(19) United States
(12) Patent Application Publication
(10) Pub. No.: US 2015/0170777 A1
(43) Pub. Date: Jun. 18, 2015

(54) RADIOACTIVE ISOTOPE LIQUID TARGETING APPARATUS HAVING FUNCTIONAL THERMOSIPHON INTERNAL FLOW CHANNEL

(71) Applicants: Bong Hwan Hong, Seoul (KR); Won Taek Hwang, Namyangju-si (KR); Tae Keun Yang, Seoul (KR); In Su Jung, Seoul (KR); Joonsun Kang, Seoul (KR); Yeun Soo Park, Sejong-si (KR)

(72) Inventors: Bong Hwan Hong, Seoul (KR); Won Taek Hwang, Namyangju-si (KR); Tae Keun Yang, Seoul (KR); In Su Jung, Seoul (KR); Joonsun Kang, Seoul (KR); Yeun Soo Park, Sejong-si (KR)

(73) Assignee: Korea Institute of Radiological & Medical Sciences, Seoul (KR)

(21) Appl. No.: 14/418,914

(22) PCT Filed: Aug. 28, 2012
(86) PCT No.: PCT/KR2012/006853

§ 371 Date: Jan. 30, 2015

(30) Foreign Application Priority Data
Aug. 20, 2012 (KR) 10-2012-0090901

(51) Int. Cl. G21G 1/10; G21H 5/00

(52) U.S. Cl. CPC G21G 1/10; G21H 5/00

(57) ABSTRACT

A radioactive isotope liquid targeting apparatus having a functional thermosiphon internal flow channel according to the present invention includes a cavity member having a cavity for accommodating a concentrate for a nuclear reaction. The cavity member includes: a front thin film having a front opening and a rear opening; a front cooling member which is coupled to the cavity member; a thermosiphon induction member which is connected to the rear opening and which has a thermosiphon flow channel connected to the cavity so as to enable the concentrate accommodated in the cavity to flow by means of a thermosiphon phenomenon; and a rear cooling member which is coupled to the rear surface of the thermosiphon induction member and which has a cooling water supply space.

### TECHNICAL FIELD

The inventive concept relates to a heavy water (H₂¹⁸O) targeting apparatus for producing isotopes having improved cooling performance in which, when ¹⁸F that is a radioactive isotope is produced using a nuclear reaction between protons and H₂¹⁸O (heavy water), heating and a rise in pressure in a cavity may be minimized when protons are radiated from energy of predetermined protons to a high current.

### BACKGROUND ART

In general, positron emission tomography (PET) is widely used in early diagnosis of tumors and various diseases.

In these days, the range of diagnosis using PET is expanded. Thus, positron emission radioactive medicines having various marked positron emission isotopes have been developed. Representative examples of these radioactive medicines include FDG (2-[18F]Fluoro-2-deoxy-D-glucose) used in cancer diagnosis and L-[11C-methyl]methionine that is useful to diagnose a brain tumor among types of cancers.

When protons are radiated to H₂¹⁸O (heavy water), ¹⁸F is generated through a ¹⁸O(p,n)¹⁸F nuclear reaction, and the protons are chemically synthesized by an apparatus for synthesizing the generated ¹⁸F so that FDG can be finally produced. Thus, an apparatus for generating 18F that is a base is required, and this apparatus is referred to as a H₂¹⁸O (heavy water) targeting apparatus. An example of the targeting apparatus is disclosed in Korean Patent Registration No. 1065057.

The amount of ¹⁸F generated in the targeting apparatus is indicated by yield. The yield of the targeting apparatus is proportional to energy of protons that are the unit of electron volts (eV) radiated in a nuclear reaction procedure and the number of protons represented as current. Total energy of proton is represented as a product of unit energy of proton and the number of protons. However, in an actual nuclear reaction procedure, only nearly a part of protons is used for the nuclear reaction, and energy of most protons is changed into heat. Thus, when energy of proton or current is increased so as to improve the yield of the targeting apparatus, H₂¹⁸O (heavy water) in the targeting apparatus absorbs a large amount of energy, and heavy water in the cavity accompanies a phase change and is a high-temperature and high-pressure state. Such a severe condition adversely affects the life span of the targeting apparatus. That is, a partial density change of heavy water occurs due to a phase change of a reactant in the cavity and high-temperature heat perturbation so that the yield of the targeting apparatus is lowered.

Thus, improving cooling efficiency of H₂¹⁸O (heavy water) in the targeting apparatus is a significant solution to improve the life span and production yield of the targeting apparatus.

When particle beams are radiated to a liquid target so as to produce radioactive isotopes, internal pressure rises together with a large amount of heat. In particular, pressure is a variable for determining the life span of the targeting apparatus. FIG. 1 is a conceptual view of a principle of cooling a concentrate accommodated in the cavity of a targeting apparatus according to the related art.

In order to increase the production yield of the radioactive isotopes, a current amount of particle beams should be increased. In order to overcome the rise in pressure caused thereby, effective cooling of the liquid target should be performed.

### DETAILED DESCRIPTION OF THE INVENTIVE CONCEPT

### Technical Problem

The inventive concept provides a targeting apparatus having an improved structure in which cooling performance is remarkably improved compared to a targeting apparatus according to the related so that heavy water in a cavity can be effectively cooled in a nuclear action procedure.

### Technical Solution

According to an aspect of the inventive concept, there is provided a radioactive isotope liquid targeting apparatus having a functional thermosiphon internal flow channel including a cavity member having a cavity for accommodating a concentrate for a nuclear reaction, and the radioactive isotope liquid targeting apparatus producing radioactive isotopes by means of the nuclear reaction between the protons radiated to the concentrate in the cavity and the concentrate, wherein the cavity member includes: a front thin film having a front opening and a rear opening which are arranged so as to be directed toward opposite sides of the proton radiation path, and which are connected to the cavity such that the cavity may communicate with the outside, the front thin film being arranged so as to close the front opening; a front cooling member which is coupled to the cavity member so as to support the front thin film such that the front thin film may not swell by means of the rise in the pressure in the cavity during the nuclear reaction, and which is arranged on the proton radiation path, the front cooling member having a plurality of through-holes formed in the proton radiation direction; a thermosiphon induction member which is connected to the rear opening and which has a thermosiphon flow channel connected to the cavity so as to enable the concentrate accommodated in the cavity to flow by means of a thermosiphon phenomenon; and a rear cooling member which is coupled to the rear surface of the thermosiphon induction member and which has a cooling water supply space.

### Effects of the Invention

In a radioactive isotope liquid targeting apparatus having a functional thermosiphon internal flow channel according to the present invention, rises in temperature and pressure of a concentrate due to a nuclear reaction in a cavity are induced in such a way that convection occurs naturally in the concentrate accommodated in the cavity due to a thermosiphon phenomenon together with cooling water so that cooling performance may be remarkably improved.

### DESCRIPTION OF THE DRAWINGS

FIG. 1 is a conceptual view of a principle of cooling a concentrate accommodated in the cavity of a targeting apparatus according to the related art.

FIG. 2 is a conceptual view of a principle of cooling a concentrate accommodated in the cavity of a targeting apparatus according to the present invention.

FIG. 3 is a cut cross-sectional view of a structure of a targeting apparatus according to an embodiment of the present invention.

FIG. 4 is an exploded perspective view of main elements of the targeting apparatus illustrated in FIG. 3.

FIG. 5 is a view of a state in which the elements illustrated in FIG. 4 are assembled with each other.

FIG. 6 is a schematic cross-sectional view of line VI-VI of FIG. 5.

FIG. 7 is a graph showing cooling performance of a targeting apparatus depending on whether a thermosiphon internal flow channel exists.

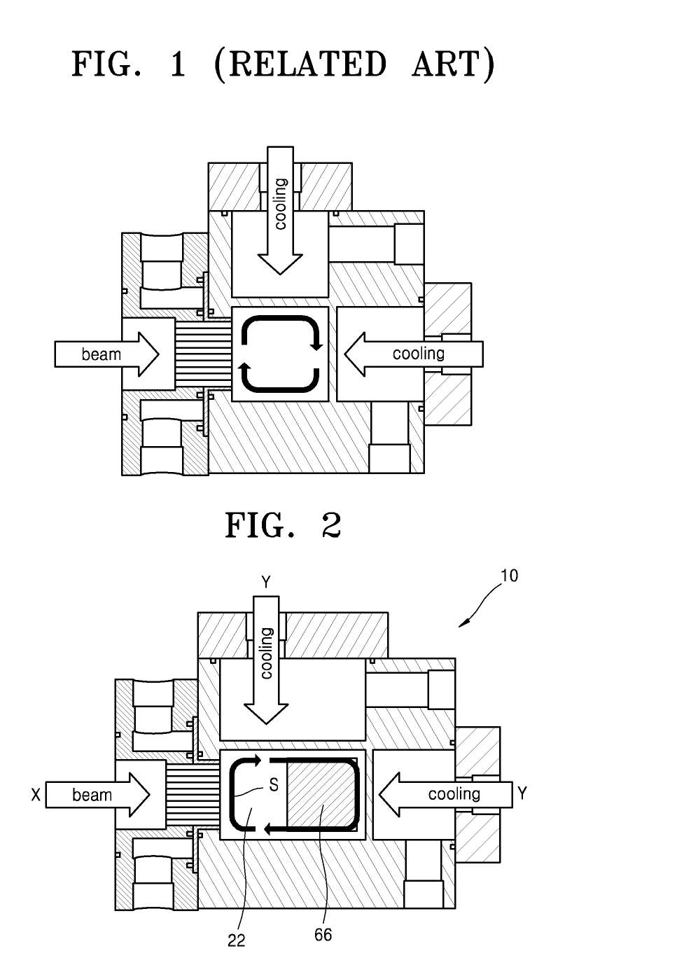

### BEST MODE

Hereinafter, exemplary embodiments of the present invention will be described in detail with reference to the attached drawings.

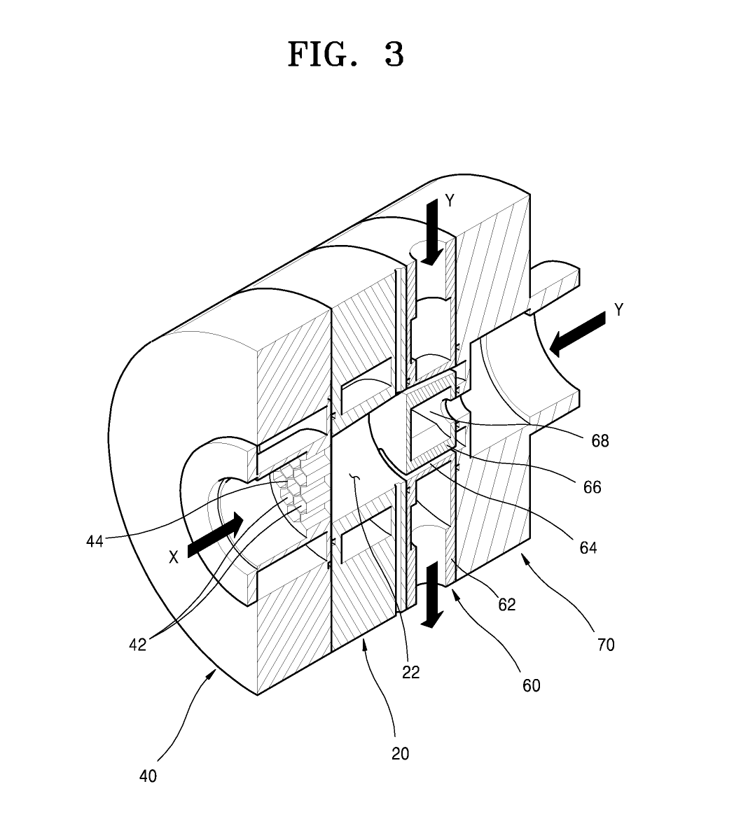

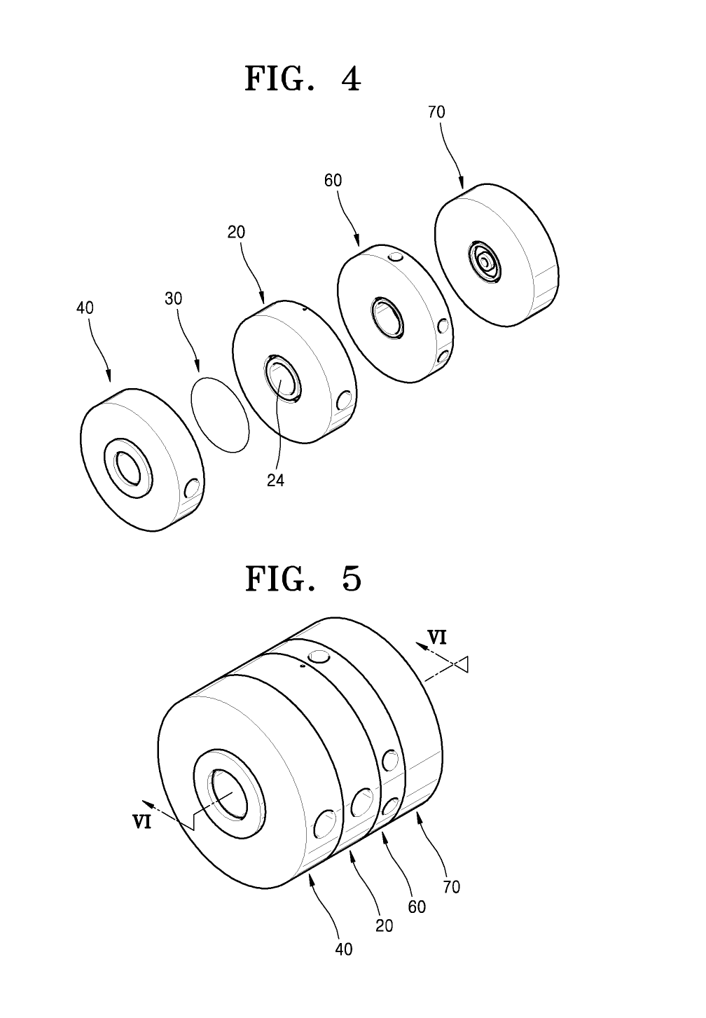

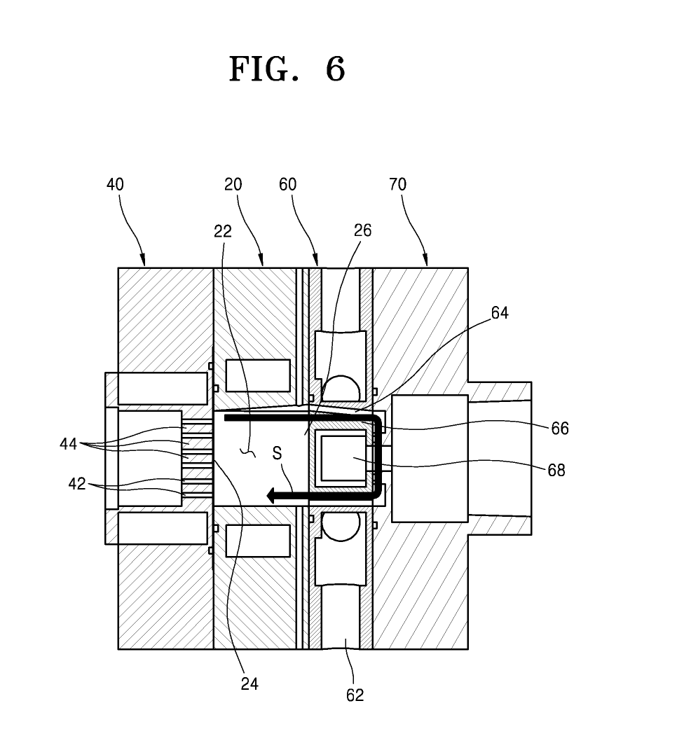

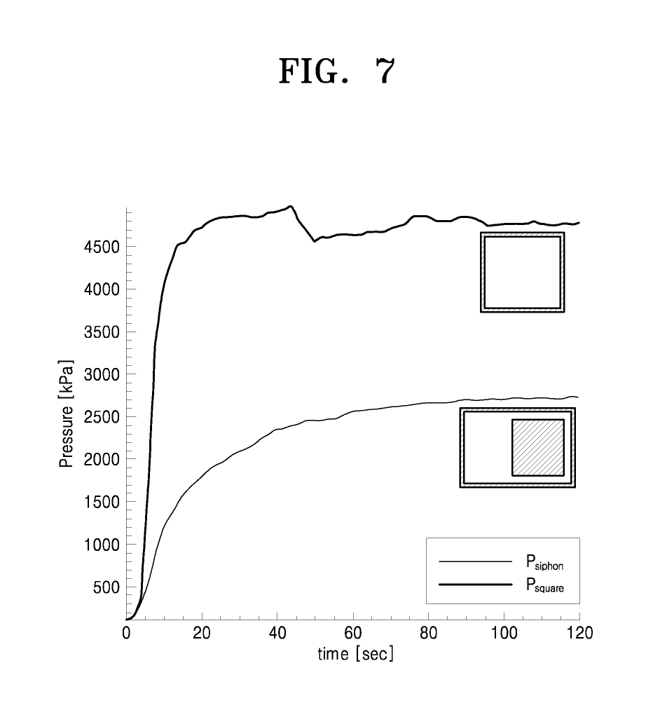

FIG. 2 is a conceptual view of a principle of cooling a concentrate accommodated in the cavity of a targeting apparatus according to the present invention. FIG. 3 is a cut cross-sectional view of a structure of a targeting apparatus according to an embodiment of the present invention. FIG. 4 is an exploded perspective view of main elements of the targeting apparatus illustrated in FIG. 3. FIG. 5 is a view of a state in which the elements illustrated in FIG. 4 are assembled with each other. FIG. 6 is a schematic cross-sectional view of line VI-VI of FIG. 5. FIG. 7 is a graph showing cooling performance of a targeting apparatus depending on whether a thermosiphon internal flow channel exists.

Referring to FIGS. 2 through 7, a radioactive isotope liquid targeting apparatus 10 (hereinafter, referred to as a “targeting apparatus”) having a functional thermosiphon internal flow channel according to an embodiment of the present invention includes a cavity member having a cavity in which a concentrate for a nuclear reaction is accommodated, and produces radioactive isotopes using a nuclear reaction between protons radiated to the concentrate accommodated in the cavity and the concentrate. The targeting apparatus is used to produce ¹⁸F using a nuclear reaction between the protons radiated to a H₂¹⁸O concentrate and the H₂¹⁸O concentrate, for example. In FIG. 2, arrow “Y” represents a flow direction of cooling water, and arrow “S” represents a flow direction of the H₂¹⁸O concentrate.

The targeting apparatus 10 includes a cavity member 20, a front thin film 30, a front cooling member 40, a thermosiphon induction member 60, and a rear cooling member 70.

The cavity member 20 includes a cavity 22, a front opening 24, and a rear opening 26. The cavity member 20 may be manufactured using metal having excellent thermal conductivity, such as copper (Cu).

The cavity 22 is a space that is formed in the center of the cavity member 20. The H₂¹⁸O concentrate is accommodated in the cavity 22. The H₂¹⁸O concentrate is H₂O in which 95% or more H₂¹⁸O is concentrated. A thermochemical stable layer plated with titanium (Ti) or niobium (Nb) may be provided on an inner circumferential surface of the cavity 22.

The cavity 22 is opened by the front opening 24 and the rear opening 26 to the outside. The cavity 22 has a circular cross section relative to a plane perpendicular to a proton radiation path. A volume of the cavity 22 is about 1.0 cc to 6.0 cc, is a volume of the H₂¹⁸O concentrate and is generally used for a nuclear reaction. Substantially, the volume of the cavity 22 is a volume including a thermosiphon flow channel 64 disposed in the thermosiphon induction member 60 that will be described later. A plurality of cooling fins may be provided on an outer circumferential surface of the cavity member 20. A space in which the cooling water flows, is formed in the cavity member 20 along a circumference of the cavity 22.

The front opening 24 and the rear opening 26 are arranged so as to be directed toward opposite sides of the proton radiation path. The front opening 24 and the rear opening 26 are connected to the cavity 22 so that the cavity 22 may communicate with the outside.

The protons are radiated to the cavity 22 through the front opening 24. All energy of the radiated protons is absorbed in the H₂¹⁸O concentrate accommodated in the cavity 22.

The front thin film 30 is disposed to cover the front opening 24. The H₂¹⁸O concentrate charged in the cavity 22 does not flow to the outside but is maintained in a state in which the H₂¹⁸O concentrate is accommodated in the cavity 22, due to the front thin film 30. The front thin film 30 is coupled to the cavity 22 in a state in which the front thin film 30 is sealed by a sealing member (not shown), such as polyethylene.

The front thin film 30 is formed of metal, such as Ti or Nb. A thickness of the front thin film 30 is generally several tens of μm. In more detail, the thickness of the front thin film 30 may be 50 μm.

The front cooling member 40 is coupled to the cavity member 20 so as to support the front thin film 30. The front thin film 30 is disposed between the front cooling member 40 and the cavity member 20. The front cooling member 40 includes a plurality of through-holes 42. The plurality of through-holes 42 are formed to pass through the front cooling member 40 in a proton radiation direction. A total area of the through-holes 42 may be 80% or more of a total area of the front opening 24. The through-holes 42 of the front cooling member 40 are not formed in a front lattice portion 44, and the protons do not pass through portions between the through-holes 42. Thus, the protons that do not pass through the front lattice portion 44 cause energy loss. Thus, the total area of the through-holes 42 is less than 80% of the total area of the front opening 24 such that excessive energy loss of the protons occurs and causes production efficiency of ¹⁸F to be lowered and thus is not preferable. The through-holes 42 may have circular or hexagonal cross sections perpendicular to the proton radiation path. The through-holes 42 are arranged in a shape of a honeycomb on their cross sections perpendicular to the proton radiation path. A space in which the cooling water flows, is formed in the front cooling member 40. When the protons are radiated, heat generated in the front lattice portion 44 of the front cooling member 40 and heat generated in the nuclear reaction are cooled by the cooling water. The front cooling member 40 may be manufactured using metal having good thermal conductivity, such as Al or Cu. The front cooling member 40 supports the front thin film 30 so that the front thin film 30 may not swell due to rises in temperature and pressure of the concentrate in the cavity 22.

The thermosiphon induction member 60 is an element for implementing an essential action effect of the present invention. A thermosiphon phenomenon is a phenomenon in which a natural convection phenomenon occurs due to a density difference caused by a change in temperatures of a medium and the flow of the medium occurs. In general, the thermosiphon phenomenon is a mechanism in which a fluid is circulated by natural convection in a state in which there is no work of a unit, such as an external pump. For example, the thermosiphon phenomenon is mainly used in solar heat heating.

The thermosiphon induction member 60 is connected to the rear opening 26. The thermosiphon induction member 60 includes a housing 62, a thermosiphon flow channel 64, a block structure 66, and a cooling water flowing portion 68.

The housing 62 is disposed to face the rear opening 26 of the cavity member 20. A space in which the cooling water is introduced and flows, is provided in the housing 62. A gasket that serves to seal the concentrate accommodated in the cavity 22 not to leak, is disposed between the housing 62 and the cavity member 20. The housing 62 and the cavity member 20 may be solidly coupled to each other using a unit, such as a bolt. That is, the cavity member 20 and the thermosiphon induction member 60 are coupled to each other using the bolt.

The thermosiphon flow channel 64 is provided so that the concentrate accommodated in the cavity 22 may flow due to the thermosiphon phenomenon. The thermosiphon flow channel 64 is connected to the cavity 22. In more detail, the thermosiphon flow channel 64 is formed in such a way that the space formed in the housing 62 is divided by the block structure 66 that will be described later. The thermosiphon flow channel 64 is a space formed between the block structure 66 and the housing 62. The thermosiphon flow channel is a flow channel connecting a ceiling and a floor of the cavity. On the thermosiphon flow channel 64, the high-temperature concentrate around the ceiling of the cavity 22 flows along an upper portion of the block structure 66 due to the thermosiphon (natural convection phenomenon) phenomenon and is cooled so that the specific gravity of the concentrate is increased and flows close to the bottom of the cavity 22. That is, the thermosiphon flow channel 64 is a path on which the concentrate accommodated in the cavity 22 is heated during the nuclear reaction and is induced so that a convection phenomenon may occur smoothly due to a difference in the generated specific gravity. The thermosiphon flow channel 64 serves to increase a heat transfer area of the concentrate.

The block structure 66 is disposed in the space of the housing 62. The thermosiphon flow channel 64 is formed by the block structure 66. The block structure 66 may be fixed to an inner circumferential surface of the housing 62 using soldering or a bolt. Meanwhile, the block structure 66 may be formed integrally with the housing 62. Inside of the block structure 66 constitutes an empty space. That is, the empty space formed in the block structure 66 constitutes the cooling water flowing portion 68 that causes the cooling water introduced into the rear cooling member 70 that will be described later, to flow. That is, the cooling water flowing portion 68 is configured in such a way that the concentrate accommodated in the cavity 22 may show an effective cooling action while the concentrate flows due to the thermosiphon phenomenon. The cooling water flowing portion 68 may be implemented due to the presence of the block structure 66. That is, the central portion of the block structure 66 occupies the central portion of the inner space of the housing 62 so that the thermosiphon flow channel 64 may be connected to the ceiling and bottom of the cavity 22.

The rear cooling member 70 is coupled to a rear portion of the thermosiphon induction member 60. The rear cooling member 70 is configured in such a way that the cooling water may be introduced/discharged into/from the rear cooling member 70 and may flow in a state in which the rear cooling member 70 is coupled to the thermosiphon induction member 60. That is, the rear cooling member 70 is coupled to the rear portion of the thermosiphon induction member 60, and a cooling water supply space is formed in the rear cooling member 70. The cooling water introduced into the rear cooling member 70 is introduced into the cooling water flowing portion 68 disposed in the thermosiphon induction member 60 and is heat-exchanged with the concentrate that flows along a circumference of the block structure 66, thereby effectively cooling the concentrate.

Meanwhile, the front cooling member 40, the cavity member 20, or the thermosiphon induction member 60 and the rear cooling member 70 may be integrally coupled to each other using a coupling unit, such as a bolt.

Hereinafter, the effects of the present invention will be described in detail while describing an example of a procedure for producing ¹⁸F using the targeting apparatus 10 according to the current embodiment having the above-described configuration. When, after protons are generated to have proper energy using particle acceleration equipment, such as cyclotron, the protons are radiated to the targeting apparatus 10 illustrated in FIG. 6, part of the protons does not pass through the front lattice portion 44 of the front cooling member 40, and all of the protons are absorbed, and the remaining part of the protons passes through the through-holes 42 of the front cooling member 40. The protons that pass through the through-holes 42 of the front cooling member 40 pass through the front thin film 30 so that part of energy of the protons is absorbed in the front thin film 30 and the remaining energy of the protons is absorbed in the H₂¹⁸O concentrate accommodated in the cavity 22 of the cavity member 20. In this way, when the protons are radiated to the H₂¹⁸O concentrate, the protons make a nuclear reaction with the H₂¹⁸O concentrate and thus, ¹⁸F is produced. Heat generated in the front lattice portion 44 of the front cooling member 40 when the protons are radiated, is cooled by the cooling water that flows through the front cooling member 40. Meanwhile, heat generated during the nuclear reaction between the protons and the H₂¹⁸O concentrate in the cavity 22 is cooled by the cooling water that flows through the cavity member 20. In this procedure, the thermosiphon induction member 60 induces the concentrate to flow through the thermosiphon flow channel 64 due to the convection phenomenon as the specific gravity of the concentrate heated by the nuclear reaction in the cavity 22 is changed. In this way, as the concentrate flows briskly through the thermosiphon flow channel 64, heat-exchanging with the cooling water that flows around the cavity 22 occurs smoothly so that temperature and pressure of the concentrate may be prevented from being excessively increased. Also, the concentrate that flows through the thermosiphon flow channel 64 heat-exchanges with the cooling water introduced into the cooling water flowing portion 68 disposed in the block structure 66 may be more quickly cooled.

In this way, the targeting apparatus according to the present invention may form a thermosiphon flow channel in a space connected to the cavity while maintaining the same volume of the cavity as that of the related art so that the concentrate heated by heat generated during the nuclear reaction may flow smoothly due to the convection phenomenon and cooling performance may be remarkably improved. Also, the cooling water is introduced into the block structure provided to form the thermosiphon flow channel so that a cooling effect of the concentrate may be maximized FIG. 7 is a graph showing cooling performance of the concentrate of the targeting apparatus depending on whether the thermosiphon flow channel exists. That is, FIG. 7 shows a change in pressure over time of the targeting apparatus having a cavity with the same volume as that of a targeting apparatus with the volume of a square cavity (20 mm×20 mm×20 mm) when proton beams of 30 MeV/20 are radiated to 8 cc of water, the targeting apparatus including the thermosiphon flow channel. According to FIG. 7, the rise in internal pressure of the targeting apparatus having the thermosiphon flow channel is remarkably lowered. From this result, cooling performance is remarkably improved when the thermosiphon flow channel is provided, like in the present invention.

### MODE OF THE INVENTIVE CONCEPT

The radioactive isotope liquid targeting apparatus having a functional thermosiphon internal flow channel according to the present invention includes a cavity member having a cavity for accommodating a concentrate for a nuclear reaction, and produces radioactive isotopes by means of the nuclear reaction between the protons radiated to the concentrate in the cavity and the concentrate. The cavity member includes: a front thin film having a front opening and a rear opening which are arranged so as to be directed toward opposite sides of the proton radiation path, and which are connected to the cavity such that the cavity may communicate with the outside, the front thin film being arranged so as to close the front opening; a front cooling member which is coupled to the cavity member so as to support the front thin film such that the front thin film may not swell by means of the rise in the pressure in the cavity during the nuclear reaction, and which is arranged on the proton radiation path, the front cooling member having a plurality of through-holes formed in the proton radiation direction; a thermosiphon induction member which is connected to the rear opening and which has a thermosiphon flow channel connected to the cavity so as to enable the concentrate accommodated in the cavity to flow by means of a thermosiphon phenomenon; and a rear cooling member which is coupled to the rear surface of the thermosiphon induction member and which has a cooling water supply space.

The thermosiphon induction member may include a block structure that occupies a central portion of the thermosiphon induction member so that the thermosiphon flow channel may be connected to a ceiling of the cavity.

A cooling water flowing portion may be formed in the block structure, and the cooling water flowing portion may be formed in such a way that the cooling water supplied to the rear cooling member may be introduced into the cooling water flowing portion.

A gasket may be disposed between the cavity member and the thermosiphon induction member so that the concentrate accommodated in the cavity may not leak, and the cavity member and the thermosiphon induction member may be coupled to each other using a bolt.

While the inventive concept has been particularly shown and described with reference to exemplary embodiments thereof, it will be understood that various changes in form and details may be made therein without departing from the spirit and scope of the following claims.

1. A radioactive isotope liquid targeting apparatus having a functional thermosiphon internal flow channel comprising a cavity member having a cavity for accommodating a concentrate for a nuclear reaction, and the radioactive isotope liquid targeting apparatus producing radioactive isotopes by means of the nuclear reaction between the protons radiated to the concentrate in the cavity and the concentrate,
wherein the cavity member comprises:
a front thin film having a front opening and a rear opening which are arranged so as to be directed toward opposite sides of the proton radiation path, and which are connected to the cavity such that the cavity may communicate with the outside, the front thin film being arranged so as to close the front opening;
a front cooling member which is coupled to the cavity member so as to support the front thin film such that the front thin film may not swell by means of the rise in the pressure in the cavity during the nuclear reaction, and which is arranged on the proton radiation path, the front cooling member having a plurality of through-holes formed in the proton radiation direction;
a thermosiphon induction member which is connected to the rear opening and which has a thermosiphon flow channel connected to the cavity so as to enable the concentrate accommodated in the cavity to flow by means of a thermosiphon phenomenon; and
a rear cooling member which is coupled to the rear surface of the thermosiphon induction member and which has a cooling water supply space.

2. The radioactive isotope liquid targeting apparatus of claim 1, wherein thermosiphon induction member comprises a block structure that occupies a central portion of the thermosiphon induction member so that the thermosiphon flow channel may be connected to a ceiling and a floor of the cavity.

3. The radioactive isotope liquid targeting apparatus of claim 2, wherein a cooling water flowing portion is formed in the block structure, and the cooling water flowing portion is formed in such a way that the cooling water supplied to the rear cooling member is introduced into the cooling water flowing portion.

4. The radioactive isotope liquid targeting apparatus of claim 1, wherein a gasket is disposed between the cavity member and the thermosiphon induction member so that the concentrate accommodated in the cavity does not leak, and the cavity member and the thermosiphon induction member are coupled to each other using a bolt.
